(19) United States
(12) Patent Application Publication
(10) Pub. No.: US 2011/0259097 A1
(43) Pub. Date: Oct. 27, 2011

(54) DEVICE FOR DETECTING A PROPERTY OF A FLOWING FLUID MEDIUM

(76) Inventors: Torsten MAIS, Ludwigsburg (DE); Michael RITTMANN, Ditzingen (DE); Oliver HENNIG, Obersulm (DE)

(21) Appl. No.: 13/086,039

(22) Filed: Apr. 13, 2011

(30) Foreign Application Priority Data
Apr. 27, 2010 (DE) 10 2010 028 267.7

(51) Int. Cl. G01F 1/69; H01R 43/00; G01F 1/68

(52) U.S. Cl. 73/204.25; 73/204.11; 29/825

(57) ABSTRACT

A device for detecting at least one property of a flowing fluid medium is proposed, in particular for detecting an air mass flow of an intake air mass. The device includes at least one sensor housing which may be at least partially introduced into the flowing fluid medium. At least one sensor element for detecting the property is accommodated within the sensor housing. At least one temperature sensor, which has at least one electric contact, in particular at least one contact wire, is furthermore accommodated in the sensor housing. At least one contact pad is furthermore accommodated in the sensor housing, the electric contact being electrically conductively connected to the contact pad at least one connecting point. The connecting point is protected against the fluid medium by at least one electrically insulating potting compound.

### RELATED APPLICATION INFORMATION

The present application claims priority to and the benefit of German patent application no. 10 2010 028 267.7, which was filed in Germany on Apr. 27, 2010, the disclosure of which is incorporated herein by reference.

### FIELD OF THE INVENTION

The present invention relates to a device for detecting at least one property of a flowing fluid medium, in particular for detecting an air mass flow of an intake air mass.

### BACKGROUND INFORMATION

Numerous devices for detecting at least one property of a flowing fluid medium are known from the related art. This at least one property may be, for example, at least one physically and/or chemically detectable property. For example, pressure, temperature, and flow properties such as velocity or volumetric flow and/or mass flow may be properties in this regard. The systems described herein are described with reference to devices which are configured to detect a mass flow and/or a volumetric flow of the fluid medium. Examples of devices of this type are described in Robert Bosch GmbH: “Sensoren im Kraftfahrzeug” (Sensors in Motor Vehicles), 2007 edition, pp. 140-142.

In particular, devices of this type may be so-called hot film air-mass meters. Hot film air-mass meters are measuring devices in which a portion of the fluid medium flow is deflected through a flow channel of the measuring device. In this channel, the flow passes along a surface of a sensor chip on which a heating element and at least two temperature sensors situated on opposite sides of the heating element are provided. A mass flow or a volumetric flow of the fluid medium may be inferred on the basis of an asymmetry of the temperature distribution which is detected by the temperature sensors.

In many commercially available hot film air-mass meters, additional temperature sensors are provided which are situated outside the actual sensor chip. These temperature sensors detect, in particular, a temperature of the flowing fluid medium. For example, these additional temperature sensors may be resistors which have a negative temperature coefficient (NTC). According to the related art, these temperature sensors are introduced in a housing of the hot film air-mass meter in a complex manner and connected to terminal contacts with the aid of resistance welding. For example, a device for measuring the mass of a flowing medium is discussed in German patent document DE 44 47 570 A1.

This device includes a temperature-dependent medium-temperature resistor, which is situated outside a measuring channel on a housing of the device at a distance from the housing, for the purpose of compensating the temperature of the flowing medium. For example, the medium-temperature resistor is part of a regulating circuit which ensures that changes in the temperature of the flowing medium do not affect the measuring accuracy of the device. For the purpose of electrical contacting, the medium-temperature resistor, which is accommodated outside a base housing, has connecting wires which are situated side by side and at least one of which is bent into a Ti shape in such a way that it runs at least partially parallel to the other connecting wire. The connecting wires are attached, for example by soldering, to two electrical holders which are designed in the form of contact pins and are electrically connected to the connecting wires. Approximately opposite a connector of the base housing, the holders project from the outer surface of the base housing into the flow cross section and are located behind each other in the flow direction.

To further hold the medium-temperature resistor, a plastic tab is provided on the base housing and protrudes from the outer surface thereof, the at least one bent connecting wire running around the plastic tab in a groove on the side of the plastic tab facing away from the holders, so that the medium-temperature resistor is situated at a distance from the outer surface of the base housing in the flowing medium due to the connecting wires. These methods and systems are comparatively complex. In addition, a technical challenge lies, in particular, in that the interface between the additional temperature sensor and the connecting pads on the housing side must be protected against corrosion and penetrating media, for example moisture, fuels, or oils.

### SUMMARY OF THE INVENTION

A device for detecting at least one property of a flowing fluid medium is therefore proposed which at least largely avoids the disadvantages of known devices described above. Furthermore, a method for manufacturing a device for detecting at least one property of a flowing fluid medium is proposed, in particular for manufacturing a device according to the present invention. With regard to the device, reference may be made, in principle, to the devices known from the related art and outlined above. In particular, the at least one property may thus be, for example, at least one physically and/or chemically detectable property. In particular, it may be a mass flow and/or a volumetric flow of the flowing fluid medium. As an alternative or in addition, however, other properties are qualitatively and/or quantitatively detectable. The flowing fluid medium may be, in particular, an intake air mass of an internal combustion engine, and the device may be used, in particular, to detect a mass flow and/or a volumetric flow of an intake air mass. However, other flowing fluid media are also conceivable in principle, for example liquids and/or other gases.

The device includes at least one sensor housing which may be at least partially introduced into the flowing fluid medium. This introduction may be carried out continuously or temporarily. For example, the sensor housing may be permanently integrated into a plug-in sensor in an intake tract of an internal combustion engine. For this purpose, the device may include, for example, a tube section through which the flowing fluid medium may flow and in which the sensor housing or a portion of the sensor housing is accommodated, in particular a plug-in sensor. As an alternative, the sensor housing may, however, also be entirely or partially inserted into a corresponding opening in an intake tract in the form of a replaceable plug-in sensor, and it may be connected to a tube wall of the intake tract, so that the device may be removed from the intake tract. Various embodiments are possible, reference being made to the above-described related art by way of example.

At least one sensor element for detecting the property is accommodated in the sensor housing. This may be done in different ways. As explained in greater detail below, for example, at least one channel through which the fluid medium may flow and in which the sensor element is at least partially situated may be situated in the sensor housing. As an alternative or in addition, however, the sensor element may also be situated on a surface of the sensor housing which directly faces the flowing fluid medium, and/or it may be situated in a cavity of the sensor housing. Different embodiments are possible.

At least one temperature sensor is furthermore accommodated in the sensor housing. Within the scope of the exemplary embodiments and/or exemplary methods of the present invention, a temperature sensor is understood to be an element which is configured to generate at least one signal which varies with the temperature or which has at least one property which is measurable and which changes with the temperature in a traceable manner. As is known from the aforementioned related art, the temperature sensor may be used as part of a compensation circuit or a regulating circuit which ensures that changes in the temperature of the medium do not affect the measuring accuracy of the device.

The temperature sensor may be situated in such a way that it is directly exposed to the fluid medium. For this purpose, the temperature sensor may be, in particular, entirely or partially situated at or on a surface of the sensor housing, at least via a measuring head, this surface being accessible to the fluid medium. As an alternative or in addition, the temperature sensor may also be entirely or partially situated in a cavity which is accessible to the fluid medium. The temperature sensor may be situated in such a way that a flow of the fluid medium is not or only slightly influenced by the temperature sensor.

The temperature sensor includes at least one electric contact, which may be at least two electric contacts, in particular at least one, which may be at least two, contact wires. At least one contact pad is accommodated in the sensor housing. The contact pad may be entirely surrounded by the material of the sensor housing, for example, by situating the contact pad in at least one cavity, or the contact pad may also be entirely or partially situated on a surface of the sensor housing. A contact pad is understood to be an electric connecting surface, for example a metallic connecting surface to which at last one electric element may be electrically conductively affixed. The at least one contact pad may be connected to at least one supply line of the device, for example to a pressed screen and/or other types of supply lines, or it is a component of at least one supply line of this type. In particular, multiple contact pads may be provided, for example at least two contact pads, it being possible for the number of contact pads to equal the number of electrical contacts of the temperature sensor, for example the number of contact wires.

It is proposed that the electric contact is electrically conductively connected to the contact pad at least one connecting point. The connecting point is protected against the fluid medium by at least one electrically insulating potting compound. This may be done in different ways. For example, the connecting point may be entirely or partially accommodated inside the sensor housing, for example in at least one cavity. For example, the electric contact may be completely or partially inserted into the cavity with the aid of at least one passage, the cavity and/or the passage being subsequently sealed by the potting compound, so that no fluid medium is able to reach the cavity or the connecting point (at least on a time scale which is characteristic for operating the device, for example on a time scale of several minutes, several hours or several days).

In particular, the at least one contact pad and/or the at least one connecting point may be accommodated within a potting trough of the sensor housing. A potting trough is understood to be an indentation and/or a cavity within the sensor housing, which may be accessible or made accessible from the outside at least during an assembly operation of the temperature sensor, and which may provide a spatial boundary for a fluid or semifluid medium which is introduced into the potting trough, at least within certain limits. For example, the potting trough may be an indentation in a wall of the sensor housing which is accessible to the fluid medium. In particular, it may be a rounded or polygonal indentation in a wall of the sensor housing and/or within a further cavity of the sensor housing.

In general, however, the concept of the potting trough is to be broadly interpreted. It may generally be any opening and/or any cavity inside the sensor housing or in a wall of the sensor housing which represents a spatial boundary for a potting compound in at least one dimension. The opening does not have to be completely filled with the potting compound. For example, the potting trough may also include a cavity within the sensor housing, as described above, into which the electric contacts of the temperature sensor, for example the electric contact wires, are inserted, for example, only the cavity and/or a portion thereof and/or an opening or passage in the potting trough being filled with the potting compound toward the outside, toward the fluid medium, so that, in particular, penetration of fluid medium or other media in the direction of the at least one connecting point may be prevented. The potting compound may thus be situated at any location in the potting trough, in particular in at least one location which is selected in such a way that penetration of media to the at least one connecting point is prevented or at least made difficult. The optional potting trough may be at least partially filled with at least one electrically insulating potting compound.

An electrically insulating potting compound is understood to be a compound which is semifluid or largely deformable at least in an initial state and which is introduced into the potting trough in a fluid or semifluid state. The potting compound may completely envelop the connecting point; the connecting point may also be a connecting region. For example, the electrically insulating potting compound may be at least one plastic which is curable and which is introduced into the potting trough in the uncured state in order to cure therein, for example, thermally, photochemically or electrically. In particular, the potting compound may be, for example, an epoxy resin and/or a silicone.

As discussed above, the device may be designed, in particular, as a hot film air-mass meter. The sensor element may be, in particular, a sensor chip or include a sensor chip, which may include at least one heating element and at least two temperature sensors, for example at least two temperature resistors. The heating element and the temperature sensors may be situated, for example, on a surface over which the fluid medium flows, so that, according to the hot film air-mass meter principle described above, an air mass flow, for example a volumetric flow and/or a mass flow, may be inferred. In particular, the device may be configured to detect the at least one property of the flowing fluid medium with the aid of the sensor element and, in addition, with the aid of at least one item of information of the additional temperature sensor.

In particular, the sensor housing may have at least one channel through which the fluid medium flows, it being possible to situate the sensor element at least partially in the channel. The sensor housing may be designed, in particular, as a largely closed housing, so that, with the exception of the optional channel, the fluid medium is unable to penetrate the inside of the sensor housing. For example, the sensor housing may be made of a plastic material. The channel may be introduced into the sensor housing, for example with aid of an appropriate injection molding technique. For example, the channel may include a main flow channel through which a main component of the fluid medium penetrating the channel flows, as well as a bypass channel which branches off this main flow channel, the sensor element may be situated in the bypass channel. Once again, reference may be made in this regard to the devices described according to the related art. The at least one temperature sensor which is introduced into the sensor housing according to the present invention may be accommodated in the sensor housing, for example outside the channel, or, as explained below, it may be accommodated within the channel or at least in the region of the channel. As discussed above, the temperature sensor may be situated in such a way that it is directly accessible to the fluid medium.

The sensor housing may have, in particular, at least one electronics region having at least one control electronic system. The control electronic system may include, for example, an electronic module, which may include, for example, a base plate and an electronic system mounted thereon. The control electronic system may include, for example, one or more elements for controlling the sensor element and/or for at least partially evaluating signals of the sensor element. The sensor element may be connected to the at least one control electronic system, for example via a sensor carrier, for example a sensor carrier made of plastic which is injection-molded onto a base plate and which extends into the at least one channel in such a way that the fluid medium may flow over at least one surface of the sensor chip accommodated in the sensor carrier. The sensor housing may furthermore have at least one fluidics region including the at least one channel. The temperature sensor may be at least partially situated in a location which lies in the electronics region and/or the fluidics region.

Further advantageous embodiments relate to the at least one potting compound. As discussed above, this potting compound may be, in particular, a curable potting compound. For example, epoxies and/or silicones may be used for this purpose. As alternatives to a curable potting compound, potting compounds may also be considered which do not fully cure, since the potting compound usually does not need to meet strict mechanical requirements. In the deformable state, for example in the fluid or semifluid state in which the potting compound is introduced into the potting trough, the sealing component should have a low viscosity so that the potting compound may completely envelop the at least one connecting point. For example, viscosities between 5,000 mPas and 20,000 mPas, in particular between 10,000 and 15,000 mPas and particularly 12,000 mPas (D=0.5 l/s), may be used. The potting compound may have, in particular, at least one media-tight material.

This means that, at least in a cured state and/or in a state which the potting compound assumes during operation of the device, the potting compound must at least largely prevent corrosion-promoting media from penetrating as far as the connecting point, or it must slow down such penetration in such a way that the effects induced by the corrosive media are negligible at least within the scope of a common life cycle of the device, which may range, for example, between one and ten years. The corrosive media may be, in particular, gases, in particular exhaust gases, and or liquids, in particular water, acids, oils, transmission fluid, or the like.

The electrically conductive connection between the contact pad and the electric contact may include, in particular, a weld connection. A weld connection is understood to be a connection, in particular a non-detachable connection, between at least two components, the connection being established by applying heat and/or pressure. Filler materials may be optionally used. The various welding techniques known from the related art may be used.

The temperature sensor may include, in principle, any element known from the related art for direct or indirect detection of a temperature. With regard to the measuring method, reference may be made to the measuring methods known from the related art. In particular, the temperature sensor may include at least one measuring resistor whose electric resistance is dependent on the temperature. In particular, the measuring resistor may be an NTC resistor, that is, a resistor having a negative temperature coefficient. This NTC may include, for example, an NTC pill, that is, an actual measuring region which is enveloped, for example, by an appropriate protective mass. In addition, the NTC may include the at least one electric contact, which may be at least two electric contacts, for example in the form of at least two contact wires. The contact wires may have an insulated design; at least one region of a contact wire, for example at least one end of a contact wire, should be insulated in each case for the purpose of establishing the connection to the particular contact pad.

The sensor housing may have, in particular, at least one attachment point, the attachment point being configured to at least partially accommodate the temperature sensor, for example a temperature-sensitive measuring head of the temperature sensor and to affix it spatially. This means that, at least under normal stress that occurs during operation of the device, the position of the affixed temperature sensor should at least no longer substantially change. The attachment point may have, for example, at least one groove and/or at least one clamp, for example in the sensor housing. As an alternative or in addition, the attachment point may also include a caulking, for example a hot caulking, between the sensor housing and the temperature sensor. The attachment point may also be situated, for example, in the region of an NTC pill of the temperature sensor, and/or the attachment point may be designed, in particular, in such a way that the actual measuring region of the temperature sensor, for example a measuring head, is affixed spatially.

The sensor housing, in particular the potting trough, may furthermore have at least one accommodating groove for accommodating the at least one electric contact. An accommodating groove is understood to be an indentation, which may be an elongated indentation, in which the at least one electric contact may be at least partially accommodated. For example, if the at least one electric contact is a contact wire, the accommodating groove may be designed as an elongated groove into which the contact wire may be completely or partially inserted. For example, this groove may lead to the at least one contact pad, so that the end of the accommodating groove lies in the region of the contact pad. The contact pad may be situated at a depth in the potting trough, so that, for example, the at least one accommodating groove ends in the region of the contact pad, and the at least one electric contact may go over from the accommodating groove to the contact pad directly and without substantial deformation of the contact pad.

In addition to the device described above in one of more of the described embodiments, a method for manufacturing a device for detecting at least one property of a flowing fluid medium is furthermore proposed, in particular a device according to one or more of the embodiments illustrated above. Reference may therefore be made to the above description of the device at least largely with regard to possible embodiments of the method. In the proposed method, a sensor housing which may be introduced into the fluid medium is produced, for example with the aid of a plastic molding method. At least one sensor element for detecting the property is accommodated in the sensor housing (for example, inside the sensor housing or on the surface of the sensor housing facing the fluid medium). At least one contact pad is furthermore situated in the sensor housing. At least one temperature sensor having at least one electric contact is furthermore accommodated in the sensor housing (for example, inside the sensor housing or on the surface of the sensor housing facing the fluid medium). The electric contact is electrically conductively connected to the contact pad at least one connecting point. The connecting point is protected against the fluid medium by at least one electrically insulating potting compound. Reference is hereby made to the fact that the method steps described above may be carried out in the illustrated order, although not necessarily so. However, another sequence is possible, and one or more method steps, for example, may be carried out at the same time and/or at overlapping times and/or repeatedly.

Reference may be made to the above description of the device for further possible details of the method. For example, the connecting point may, in turn, be situated in at least one potting trough. In particular, at least one casting process may be used for introducing the potting compound, for example for filling the potting trough with the potting compound. In particular, at least one welding method may be used to establish the electric connection between the electric contact and the contact pad. In particular, this welding method may be a stepped welding method or include a stepped welding method. Within the scope of the exemplary embodiments and/or exemplary methods of the present invention, a stepped welding method is understood to be a welding method in which the power is varied during welding, for example in one or more steps and/or via a continuous variation. In particular, this may be a high-frequency power in the case of ultrasonic welding. In general, ultrasonic welding methods or other types of welding methods are possible within the scope of the exemplary embodiments and/or exemplary methods of the present invention.

The proposed method and the proposed device have numerous advantageous over known methods and devices. In particular, an additional temperature sensor which meets the requirements of media tightness may be integrated into a sensor housing. In particular, the temperature sensor may be integrated in a corrosion-resistant and yet safe and reliable manner. This makes it possible to substantially increase the life of the device, and failure due to corrosion may be largely avoided.

The temperature sensor may be accommodated, in particular, at least partially in a recess of the sensor housing which is accessible to the fluid medium. For example, the recess may be a recess in a side surface of a plug-in sensor of the sensor housing, so that the entire temperature sensor does not project over the side boundary of the housing and in this manner does not produce any disturbances in the flow of the fluid medium, yet the temperature sensor is in direct contact with the flowing fluid medium. In this regard, reference is hereby made by way of example to DE 44 47 570 A1 cited above.

In this embodiment, in particular, the media-tight electric contacting according to the present invention is particularly favorably noticeable, since the contact points in conventional devices are directly exposed to corrosive components of the fluid medium in this case. However, this disadvantage is avoided by the proposed invention. A measuring head of the temperature sensor, that is, the actual temperature-sensitive region of the temperature sensor, may be situated, for example with the aid of the attachment point described above, in such a way that this measuring head is situated at a distance from the wall of the sensor housing, for example at a distance from the wall of the sensor housing within the indentation, so that, for example, no direct thermal contact exists between the measuring head and the sensor housing.

Exemplary embodiments of the present invention are illustrated in the figures and explained in greater detail in the following description.

### BRIEF DESCRIPTION OF THE DRAWINGS

FIG. 1 shows an exemplary embodiment of a conventional device for detecting a property of a flowing fluid medium.

FIG. 2 also shows an exemplary embodiment of a conventional device for detecting a property of a flowing fluid medium.

FIG. 3 shows a device according to the present invention having a temperature sensor which is attached according to the present invention.

### DETAILED DESCRIPTION

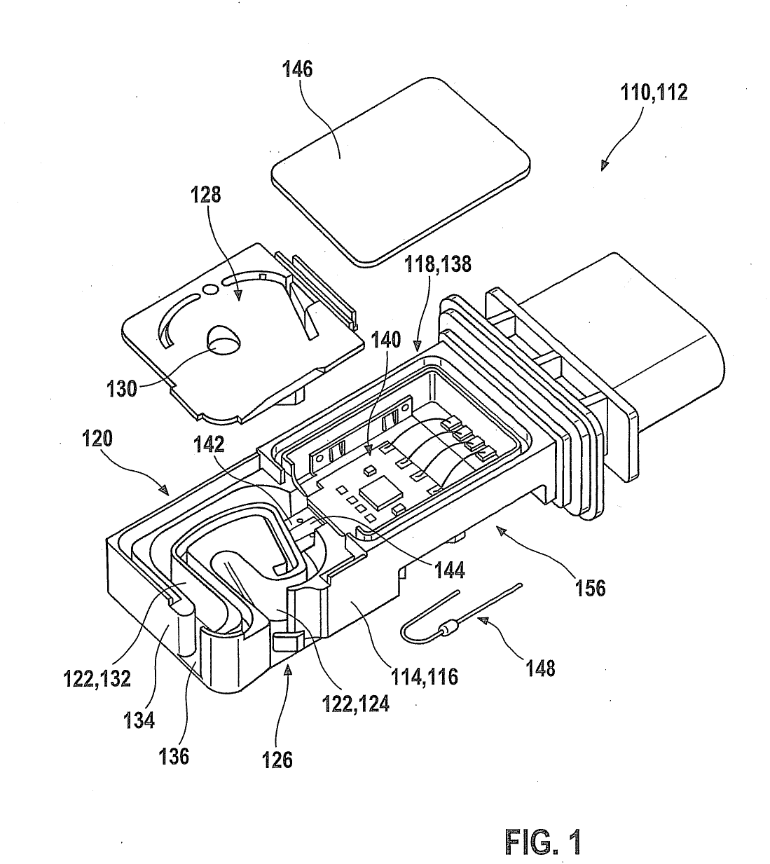

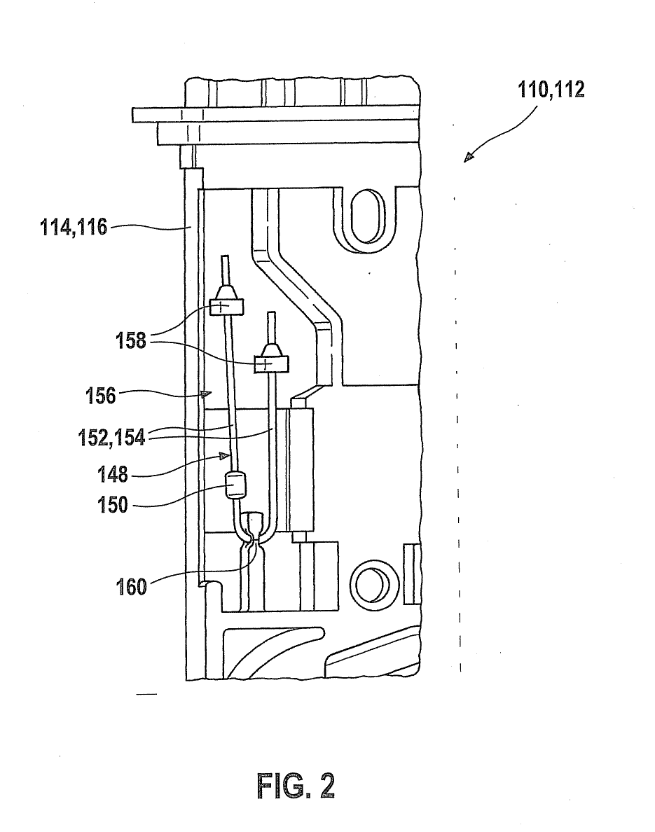

FIGS. 1 and 2 show a device 110 known from the related art for detecting at least one property of a flowing fluid medium. By way of example, this is a so-called hot film air-mass meter 112 of the HFM6 type from Robert Bosch GmbH. In principle, reference may be made to Robert Bosch GmbH: Sensoren im Kraftfahrzeug (Sensors in Motor Vehicles), 2007 edition, pages 140-142, for the structure and functionality of this hot film air-mass meter 112. Hot film air-mass meter 112 includes a plug-in sensor 114 which may be introduced into the fluid medium. This plug-in sensor 114, in turn, includes a sensor housing 116, which is typically made of a plastic. An electronics region 118 and a fluidics region 120 are provided in sensor housing 116. Fluidics region 120 includes multiple channels 122, namely a main channel 124 having an end-face inlet opening 126 and a side outlet opening 130 situated in a bypass cover 128; the fluidics region also includes a bypass channel 132 which branches off from main channel 124 and which ends in a bypass outlet 136 on an end surface 134 of plug-in sensor 114. A control electronic system 138 having an electronic module 140 is provided in electronics region 118. A sensor carrier 142 in the form of a plastic panel which extends into bypass channel 132 and in which a sensor chip 144 is accommodated is injection-molded onto this electronic module 140. This sensor chip 144, over which the fluid medium in bypass channel 132 flows, operates according to the principle of a hot film air-mass meter. Electronics region 118 is closed by an electronic chamber cover 146 and fluidics region 120 is closed by bypass cover 128.

While FIG. 1 shows a perspective representation of device 110 in the open state, FIG. 2 shows a rear view of device 110 according to FIG. 1 from a side opposite electronics region 118 or fluidics region 120. As shown in the drawing, an optional temperature sensor 148 is available for commercial devices 110 according to FIGS. 1 and 2. These may be, for example, an NTC resistor or a PTC resistor. This temperature sensor 148 corresponds to the medium-temperature resistor described in DE 44 47 570 A1, which is provided outside channel 122 in sensor housing 116, and which may be connected, for example, to control electronic system 138. The signal of temperature sensor 148 may be used, in particular, to compensate the temperature of the flowing fluid medium.

As shown in particular, in FIG. 2, temperature sensor 148 in the illustrated exemplary embodiment has a measuring head 150 which represents the actual measuring point of temperature sensor 148 and which is also frequently referred to as the “pill,” for example as the NTC pill. In the illustrated exemplary embodiment, temperature sensor 148 furthermore has electric contacts 152 in the form of contact wires 154, temperature sensor 148 being bent into a U shape and contact wires 154 running at least largely parallel to each other. Optional temperature sensor 148 is mounted in a recess 156 on the back of plug-in sensor 114. Holders 158, which protrude from the wall surface of sensor housing 116 in recess 156 and to which contact wires 154 are connected with the aid of resistance welding, are provided for electrical contacting. These holders 158 establish connections to a conductor comb of hot film air-mass meter 112, so that, for example, a connection between control electronic system 138 and temperature sensor 148 may be created in this manner. To further attach and affix the vibrating load, temperature sensor 148 is additionally attached to an attachment point 160 in the region of measuring head 150 with the aid of hot caulking. In particular, an NTC in a variant having tin-plated wires without any special corrosion protection means is used as temperature sensor 148.

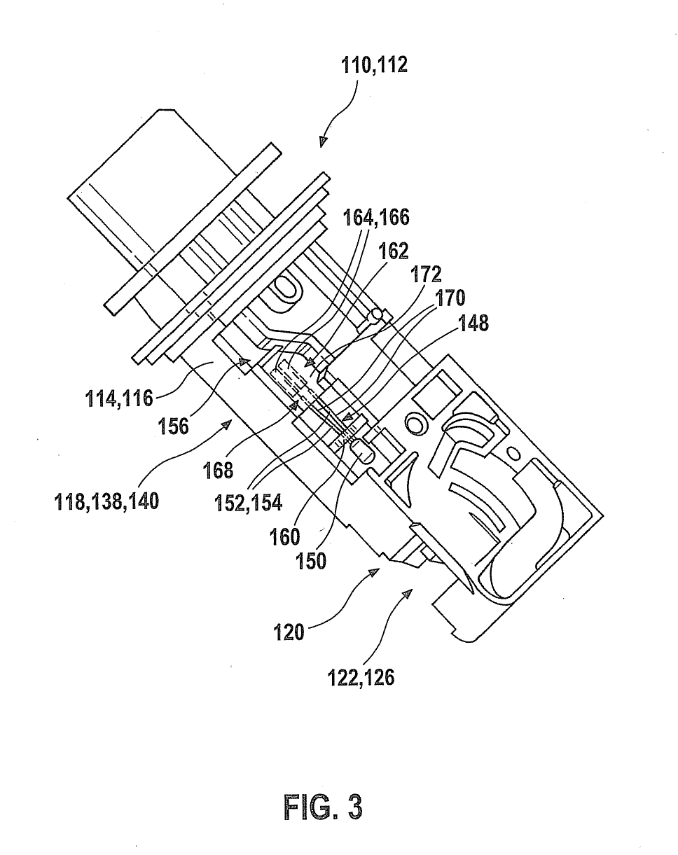

FIG. 3, on the other hand, shows a perspective representation of a device 110 manufactured according to the present invention, viewed on the side of the device illustrated in FIG. 2, that is, a device which is located opposite electronics region 118 and fluidics region 120 (which are not visible in FIG. 3). Device 110 largely corresponds to the device illustrated in FIGS. 1 and 2, so that reference may be made at least largely to this device 110. Once again, a temperature sensor 148, for example an NTC or a PTC (temperature resistor having a positive temperature coefficient) is provided on the illustrated back of plug-in sensor 114. This temperature sensor, in turn, includes a measuring head 150 as well as electric contacts 152 in the form of contact wires 154. Temperature sensor 148 is again electrically attached spatially by an attachment point 160 within a recess 156 in sensor housing 116, for example with the aid of hot caulking, in the region of measuring head 150, i.e., on contact wires 154 directly upstream from measuring head 150.

To ensure the corrosion and media resistance of temperature sensor 148 and its interface to the electronic system of device 110, for example to a conductor comb, protection for connecting points 162 to contact pads 164 of conductor comb 166 is also provided in addition to using what may be a corrosion- and medium-resistant temperature sensor 148 having what may be sheathed contact wires 154 and a sheathed measuring head 150. Contact pads 164 form the connection to conductor comb 166 and, according to the present invention, are situated in a potting trough 168. This potting trough 168 represents an indentation in the wall of sensor housing 116 in the region of optional recess 156. Accommodating grooves 170, in which the contact wires 154 are accommodated and which, together with attachment point 160, are used to position temperature sensor 148, extend from an attachment point 160 forming an attachment region. In the region of contact pads 164, contact wires 154 may be insulated and situated within potting trough 168. The contacting between contact wires 154 and contact pads 164 may be established with the aid of a welding method, in particular with the aid of a stepped welding method. To protect connecting points 162 and insulated contact wires 154 within potting trough 168 against corrosion and media contamination, potting trough 168 is at least partially filled with a potting compound 172 after the welding process. The walls of potting trough 168 represent an outer boundary of the potting process.

As an alternative, connecting point 162, for example the weld connection, may also be established inside plug-in sensor 114. For this purpose, contact wires 154 are inserted, for example, through an opening into the interior of sensor housing 116, where they are appropriately bent and welded to the conductor comb. To protect the opening of sensor housing 116 against media penetration, this opening is at least partially sealed with the aid of potting compound 172.

What is claimed is:

1. A device for detecting at least one property of a flowing fluid medium, including detecting an air mass flow of an intake air mass, comprising:
at least one sensor housing, wherein the sensor housing is at least partially introduce-able into the fluid medium;
at least one sensor element, in the sensor housing, for detecting the property;
at least one temperature sensor in the sensor housing, wherein the at least temperature sensor has at least one electric contact, which includes at least one contact wire; and
at least one contact pad in the sensor housing;
wherein the at least one electric contact is electrically conductively connected to the at least one contact pad at least one connecting point, which is protected against the fluid medium by at least one electrically insulating potting compound.

2. The device of claim 1, wherein the connecting point is within a potting trough, and wherein the potting trough is at least partially filled with the potting compound.

3. The device of claim 1, wherein the device includes a hot film air-mass meter, wherein the sensor element includes a sensor chip, and wherein the sensor chip includes at least one heating element and at least two temperature sensors.

4. The device of claim 1, wherein the sensor housing has at least one channel through which the fluid medium may flow, and wherein the sensor element is at least partially situated in the channel.

5. The device of claim 1, wherein the temperature sensor is at least partially in a recess of the sensor housing which is accessible to the fluid medium.

6. The device of claim 1, wherein the potting compound has at least one media-tight material.

7. The device of claim 1, wherein the electrically conductive connection between the contact pad and the electric contact includes a weld connection.

8. The device of claim 1, wherein the temperature sensor includes a resistor having a negative temperature coefficient.

9. The device of claim 1, wherein the sensor housing has at least one attachment point, and wherein the attachment point is configured to at least partially accommodate the temperature sensor and affix it spatially.

10. The device of claim 1, wherein a potting trough of the sensor housing has at least one accommodating groove for accommodating the at least one electric contact.

11. A method for manufacturing a device for detecting at least one property of a flowing fluid medium, the method comprising:
producing at least one sensor housing that is introduce-able into a fluid medium;
accommodating at least one sensor element for detecting the property in the sensor housing;
situating at least one contact pad in the sensor housing;
accommodating at least one temperature sensor, having at least one electric contact, in the sensor housing, wherein the at least one electric contact is electrically conductively connected to the at least one contact pad at least one connecting point, and wherein the connecting point is protected against the fluid medium by at least one electrically insulating potting compound.

12. The method of claim 1, wherein a welding process is used for the electric connection between the at least one electric contact and the at least one contact pad.

13. The method of claim 1, wherein a stepped welding process is used for the electric connection between the at least one electric contact and the at least one contact pad.
